(19) United States
(12) Patent Application Publication
(10) Pub. No.: US 2020/0075196 A1
(43) Pub. Date: Mar. 5, 2020

(54) ELECTRICAL CABLE AND METHODS OF MAKING THE SAME

(71) Applicant: Trilogy Communications, Inc., Pearl, MS (US)

(72) Inventors: Chris A. Eitel, Brandon, MS (US); Craig L. Tetrick, Brandon, MS (US)

(21) Appl. No.: 16/477,383

(22) PCT Filed: May 28, 2019
(86) PCT No.: PCT/US2019/034153

§ 371 Date: Jul. 11, 2019

Related U.S. Application Data
(60) Provisional application No. 62/681,177, filed on Jun. 6, 2018.

(51) Int. Cl. H01B 7/295; H01B 11/18; H01B 7/02

(52) U.S. Cl. CPC H01B 7/295; H01B 7/0275; H01B 11/1808

(57) ABSTRACT

Systems and methods for making an electrical cable. The electrical cable comprises: an inner conductor member formed of a conductive material; a dielectric member disposed as a single non-solid layer on the inner conductor member such that the inner conductor member is only partially covered by the dielectric member (the dielectric member being formed of a silica material (a) with a melting point equal to or greater than 1500° F., (b) that does not experiences a transformation from a flexible material to a rigid material when exposed to temperatures less than 1000° F., and (c) that comprises 60% or more silica); and an outer conductor member that is formed of a conductive material, encompasses the dielectric member and the inner conductor member, and is coaxial with the inner conductor member.

### CROSS-REFERENCE TO RELATED APPLICATIONS

The present application claims the benefit of U.S. Patent Application Ser. No. 62/681,177 filed on Jun. 6, 2018. The content of which are incorporated herein by reference in its entirety.

### BACKGROUND

Statement of the Technical Field

The present disclosure relates generally to electrical cables. More particularly, the present disclosure relates to electrical cables and methods of making the same.

### DESCRIPTION OF THE RELATED ART

Circuit Integrity (“CI”) cables have traditionally been used to provide electrical power and/or data transmission to equipment and electrical systems that are required to function during a fire. The equipment includes, but is not limited to, fire suppression equipment and/or plenum cables. The electrical systems include, but are not limited to, fire alarm controllers, sprinkler pumps, communication systems, lighting systems, elevator systems, and/or ventilation systems.

Such CI cables are required to continue to operate and provide circuit integrity when they are subjected to fire. To meet certain standards, the CI cables must maintain electrical circuit integrity when heated to a specified temperature in a prescribed way for a specified period of time (e.g., 15 minutes, 30 minutes, 60 minutes, 2 hours). In some cases, the CI cables are subjected to regular mechanical shocks, before being heated, while being heated, and/or after being heated. The CI cables are also often subjected to water jet spraying, either in the latter stages of the heating cycle or after completion of the heating cycle in order to gage the CI cables' performance against other factors likely to be experienced during a fire.

Such CI cables are required to be fire tested for circuit integrity compliance in accordance with a given Compliance Standard. The fire test involves: installing the CI cable(s) in a manufacturer's specified system; and testing the CI cable(s) for functionality in a furnace that models petroleum-fueled fire.

Compliance standards may be developed by U.S. certification companies. For instance, Underwriters Laboratories (“UL”) has developed Compliance Standard UL 2196, 2012 (“UL 2196”). To obtain a UL 2196 certification, the circuit integrity of electrical cables is evaluated during a UL 2196 test. The UL 2196 test involves evaluating the circuit integrity of electrical cables during a period of fire exposure and evaluating the circuit integrity of electrical cables during subsequent exposure to a fire hose stream. In order to meet the requirements of the UL 2196 test, electrical functionality of the electrical cables must be maintained throughout the fire exposure period and the following fire hose stream exposure period. The UL 2196 test is intended to evaluate the fire resistive performance of the electrical cables as measured by functionality during a period of fire exposure, and during a period of following fire hose stream exposure.

In order to maintain the functionality of the electrical cables during a fire exposure, the electrical cables are tested using a fire resistive barrier. The fire resistive barrier may be provided by a cable jacketing that is designed to provide fire resistance. If the cable jacketing is not designed to provide fire resistance, the electrical cables are either placed within a fire resistive barrier or installed within an hourly rated fire resistive assembly. Fire resistive cables intended to be installed with a non-fire resistive barrier (such as a conduit) are tested with the non-fire resistive barrier included as part of the test specimen. Otherwise fire resistive cables incorporating a fire resistive jacket are tested without any barrier. To demonstrate each cable's ability to function during the test, voltage and current are applied to the cable during the fire exposure portion of the UL 2196 test. The electrical and visual performance of the cable is monitored. The cable is not energized during the fire hose spray portion of the UL 2196 test, but it is visually inspected and electrically tested after the fire hose spray portion of the UL 2196 test.

One of the most widely used communication cables in a building is a coaxial cable. Coaxial cables typically include a center conductor surrounded by an outer conductor. The outer conductor is spaced apart from the center conductor via a dielectric (e.g., air or dielectric material). The dielectric is chosen such that it has good electrical conductivity properties. However, such dielectric cannot withstand high temperatures required by CI cables and disintegrates at about 300-400° F.

### SUMMARY

The present disclosure concerns implementing systems and methods for making an electrical cable. The electrical cable comprises: an inner conductor member formed of a conductive material; a dielectric member disposed as a single non-solid layer on the inner conductor member such that the inner conductor member is only partially covered by the dielectric member; and an outer conductor member that is formed of a conductive material, encompasses the dielectric member and the inner conductor member, and is coaxial with the inner conductor member. The dielectric member is formed of a silica material (a) with a melting point equal to or greater than 1500° F., 1850° F. or 2200° F., (b) that does not experiences a transformation from a flexible material to a rigid material when exposed to temperatures less than 1000° F. or 1850° F., and (c) that comprises 60% or more silica. The diameters of the inner conductor member, dielectric member, and outer conductor member may be selected to produce an impedance value for the electrical cable of 50 ohms or 75 ohms.

In some scenarios, the dielectric member comprises a rope. The rope is helically wrapped around the inner conductor member. A lay length of the rope may be between 1.0 inches and 1.5 inches in those or other scenarios.

In those or other scenarios, the dielectric member comprises a plurality of discs. The plurality of discs are formed of a silica rubber. Adjacent discs have equal spacing therebetween or different spacing therebetween.

In those or other scenarios, the dielectric member is coupled to the inner conductor member. The outer conductor member is corrugated. A protective jacket may be provided that encases the outer conductor member.

In those or other scenarios, the electrical cable is transformed into a circuit integrity cable structure using a conduit wrapped in at least one layer of fire insulating material. The circuit integrity cable structure meets a UL 2196 Compliance Standard.

The methods comprise: forming an inner conductor member from a conductive material; disposing a dielectric member as a single non-solid layer on the inner conductor member such that the inner conductor member is only partially covered by the dielectric member, the dielectric member formed of a material with silica properties and a melting point equal to or greater than 1500° F.; and forming an outer conductor member from a conductive material, the outer conductor member encompassing the dielectric member and the inner conductor member, and is coaxial with the inner conductor member.

### BRIEF DESCRIPTION OF THE DRAWINGS

The present solution will be described with reference to the following drawing figures, in which like numerals represent like items throughout the figures.

FIG. 1 is an illustration of an illustrative coaxial cable.

FIG. 2 is a cross-sectional view of the coaxial cable shown in FIG. 1

FIG. 3 is an illustration of a coaxial cable with an optional protective jacket.

FIG. 4 is an illustration of the coaxial cable shown in FIGS. 1-2 with a fire insulating material disposed thereon.

FIG. 5 is an illustration of the coaxial cable shown in FIG. 3 with a fire insulating material disposed thereon.

FIG. 6 is an illustration of another illustrative coaxial cable.

FIG. 7 is an illustration of yet another illustrative coaxial cable.

FIG. 8 is a method of making a CI cable in accordance with the present solution.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment”, “an embodiment”, or similar language means that a particular feature, structure, or characteristic described in connection with the indicated embodiment is included in at least one embodiment of the present solution. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

When used in this document, terms such as “top” and “bottom,” “upper” and “lower”, or “front” and “rear,” are not intended to have absolute orientations but are instead intended to describe relative positions of various components with respect to each other.

The present document concerns electrical cables and methods of making the same. The electrical cables include, but are not limited to, coaxial cables. The electrical cables of the present solution continue to operate at temperatures up to 1100° F. or 1850° F., while conventional coaxial cables fail at about 300° F. This feature of the present solution allows the electrical cables to be used as stand-alone components or in combination with a conduit or insulation materials to meet high temperature circuit integrity requirements of fire codes easier than existing coaxial cables. The electrical cables of the present solution has been certified to meet the UL 2196 Compliance Standard requirements when used in combination with a conduit encompassed by an insulating fire material (e.g., an insulating fire material Interam™ Endothermic Mat 5-5A-4 available from 3M of Maplewood, Minn.

One prior art cable is described in U.S. Pat. No. 9,773,585 to Rogers (“the '585 patent”). The prior art cable includes a center conductor member and an outer conductor member spaced apart from each other by a multi-layer dielectric member. The multi-layer dielectric member comprises a plurality of solid layers of a dielectric material that is entirely absent of any silica or is 60% or less silica, where the plurality of solid layers are encompassed by a layer of silicon glass separator tape. Although this cable can survive conditions of 1850° F., it is complex and costly to manufacture.

Accordingly, the present solution provides an electronic cable that can survive high temperature conditions, has a less complex design, and is less costly to manufacture. In this regard, it should be understood that the dielectric member of the present solution electronic cable (1) is formed as a single non-solid layer on the inner conductor member such that the inner conductor member is only partially covered by the dielectric member (and not entirely surrounded or covered by the dielectric as is the case in the '585 patent), (2) is formed of a silica material with a melting point equal to or greater than 1500° F., 1850° F. or 2200° F. (and not formed of a component material with a melting point between 350° C. (or 677° F.) and 482° C. (or 899.6° F.) as taught in the '585 patent), (3) is formed of a silica material that never transforms from a flexible material to a ceramic when exposed to temperatures less than 1000° F. or 1850° F. as taught in the '585 patent, and (4) is formed of a material that comprises 60% or more silica (and not 60% or less silica as is suggested by the chemical compositions of the dielectric materials discussed in the '585 patent). In some scenarios, the melting point is equal to or greater than 2200° F. instead of 1500° F. The dielectric member configuration of the present solution eliminates the need for any additional layers of dielectric material and/or silicon glass separator tape, and therefore simplifies the overall cable design and reduces the cost of manufacture.

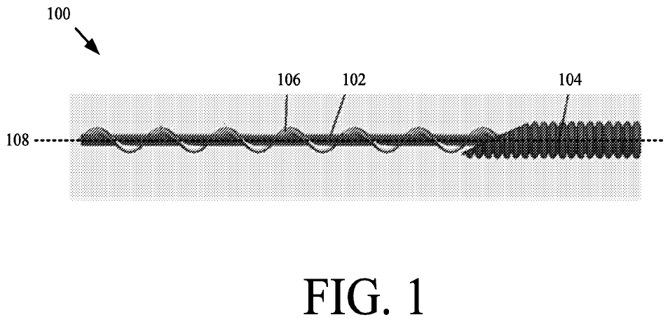

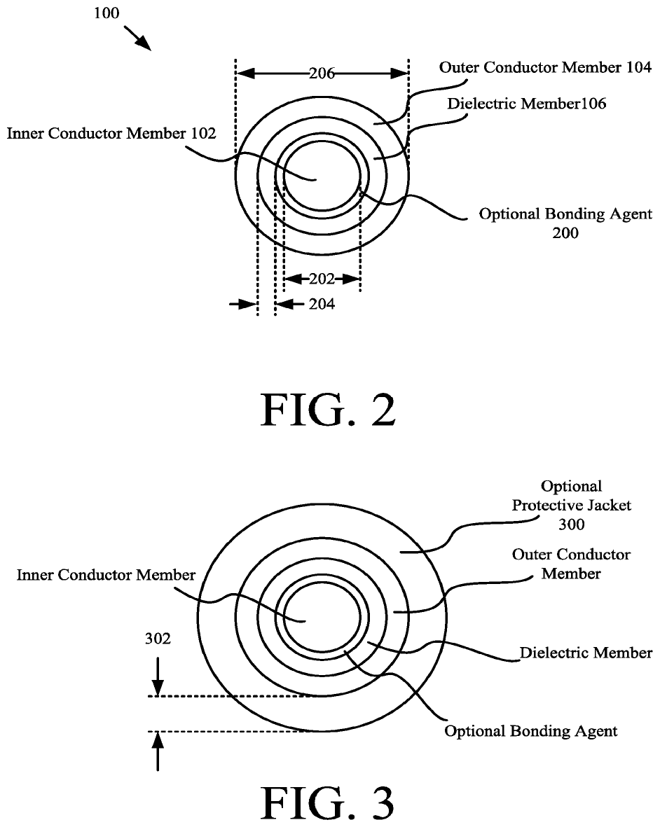

Referring now to FIGS. 1-2, there is provided an illustration of an illustrative electrical cable 100 in accordance with the present solution. It should be noted that, for drawing simplicity and clarity, FIGS. 1-2 are not drawn to scale. Electrical cable 100 is shown as comprising a coaxial cable. The present solution is not limited in this regard.

Coaxial cable 100 is used as a transmission line for Radio Frequency (“RF”) signals. In this regard, the coaxial cable 100 may be used as a feedline connecting a radio transmitter to an antenna, a feedline connection a radio receiver to an antenna, a feedline connecting a radio transceiver to an antenna, a computer network cable, a digital audio cable, a cable television cable, or a power cable.

In some scenarios, the coaxial cable 100 is disposed in a building. A fire may occur in the building, and spread throughout the building by traveling along the length of cables. In order to prevent the spread of fire in buildings, the coaxial cable 100 is designed such that it is resistant to catching fire and/or such that it maintains a desired attenuation coefficient α for losses in conductors of the cable at relatively high temperatures (e.g., >300° F.).

As shown in FIG. 1, coaxial cable 100 has a round cross-sectional profile and is radially symmetric around an axial center axis 108. The coaxial cable 100 comprises an inner conductor member 102, an outer conductor member 104, and a dielectric member 106. The inner conductor member 102 is surrounded by the outer conductor member 104. The outer conductor member 104 is spaced from the inner conductor member 102. The space between the two conductor members 102, 104 comprises the dielectric member 106.

The inner conductor member 102 is formed of an electrically conducting material that has a relatively high temperature resistance. Such electrically conducting materials include, but are not limited to, copper, copper alloys, copper plated steel, or aluminum. The inner conductor member 102 is flexible and comprises a solid wire, a hollow wire, a stranded wire, a corrugated wire, a plated wire, or a clad wire.

The inner conductor member 102 has a circular cross-sectional profile, as shown in FIG. 2. A diameter 202 of the inner conductor member 102 can have a value between 0.150 inches and 0.200 inches. For example, in some scenarios, the diameter 202 is about 0.150 inches to about 0.200 inches, about 0.160 inches to about 0.190 inches, 0.170 inches to about 0.180 inches, about 0.180 inches, about 0.185 inches, about 0.188 inches, or about 0.190 inches. The present solution is not limited to the particulars of this example.

The dielectric member 106 comprises a rope that is helically wrapped around the inner conductor member 102. The rope comprises a single rope or multiple ropes braided together. The rope is formed from a dielectric material. The dielectric material includes, but is not limited to, a silica material (a) with a melting point equal to or greater than 1500° F., (b) that does not experiences a transformation from a flexible material to a rigid material when exposed to temperatures less than 1000° F., and (c) that comprises 60% or more silica. Such materials include, but are not limited to, silica, a silica based woven rope, a silica-rubber based polymer (e.g., silicone rubber), and/or zirconia. The dielectric member 106 provides a cable 100 that operates in temperatures up to 1100° F. or 1850° F. (e.g., in a temperature range of 0° F.-1100° F. or 1850° F., or a temperature range of 300° F.-1100° F. or 1850° F.), while maintaining a desired attenuation coefficient α for losses in conductor members 102, 104.

As noted above, conventional coaxial cables fail at about 300° F. This failure is due to the fact that the dielectric member is formed of a polyethelene material that could be solid, foamed, or extruded shape has a softening point around 300° F. In contrast, the dielectric member 106 of the present solution is not a solid layer formed over the inner conductor member 102, but rather has a non-solid arrangement and is formed of a silica material (a) with a melting point equal to or greater than 1500° F., (b) that does not experiences a transformation from a flexible material to a rigid material when exposed to temperatures less than 1000° F., and (c) that comprises 60% or more silica. A cable 100 that is operative at temperatures greater than 300° F. is surprising and an unexpected result from use of such a non-solid layer of silica material.

In some scenarios, a lay length of the helically wrapped dielectric rope may be between 1.0 inch and 1.5 inches. The term “lay length”, as used herein, refers to the distance between a full revolution of the dielectric member 106 around the inner conductor member 102. For example, in some scenarios, the lay length is about 1.00 inch to about 1.50 inches, about 1.10 inches to about 1.40 inches, about 1.20 inches to about 1.30 inches, about 1.20 inches, about 1.25 inches, or about 1.30 inches. The present solution is not limited to the particulars of this example.

The dielectric member 106 has a circular cross-sectional profile, as shown in FIG. 2. The present solution is not limited in this regard. The dielectric member 106 can have other cross-sectional profile shapes such as square. In the circular cases, the diameter 204 has a value between 0.100 inches to 0.400 inches. For example, in some scenarios, the diameter 204 is about 0.100 inches to about 0.400 inches, about 0.100 inches to about 0.300 inches, about 0.200 inches, about 0.250 inches, about 0.300 inches, or about 0.350 inches.

An optional bonding agent 200 may be provided as shown in FIG. 2. The bonding agent 200 is provided to couple, attach or adhere the dielectric member 106 to the inner conductor member 102. This coupling or attachment prevents movement of the dielectric member 106 relative to the inner conductor member 102 while the coaxial cable 100 is being manufactured or in use. The bonding agent 200 includes, but is not limited to, an adhesive. The adhesive can comprise an ethylene-acrylic acid copolymer cement or a resin copolymer.

The outer conductor member 104 is disposed around the inner conductor member 102, optional bonding agent 200, and dielectric member 106. The outer conductor member 104 is coaxial with the inner conductor member 102 meaning that they both have a common elongate center axis 108. The outer conductor member 104 is formed from an electrically conductive material. The electrically conductive material includes, but is not limited to, copper and/or aluminum.

As shown in FIG. 1, the outer conductor member 104 is annularly corrugated to provide flexibility to the coaxial cable 100, as well as to provide resistance to forces caused by differential thermal expansion between the inner conductor member 102 and outer conductor member 104. The present solution is not limited in this regard. The outer conductor member 104 may alternatively be smooth or corrugated helically.

The outer conductor member 104 has an outermost diameter 206 between 0.24 inches to 0.80. The diameters 202, 204, 206 are selected to provide a coaxial cable with a required impedance value (e.g., 50 ohms or 75 ohms), attenuation, and/or return loss.

An optional protective jacket 300 may be provided as shown in FIG. 3 to protect the components 102, 104, 106 of the coaxial cable 100. Notably, FIG. 3 is not drawn to scale for drawing simplicity and clarity. The protective jacket 300 is disposed on and encases the outer conductor member 104. The protective jacket 300 is formed of a material that renders the coaxial cable 100 flame retardant, smoke suppressive, and/or flexible. Such material includes, but is not limited to, a plenum rated material, a fire retardant material, a smoke suppressive material, and/or a halogenated polymer material. The halogenated polymer material may comprise Fluorinated Ethylene-Propylene (“FEP”), Ethylene ChloroTriFluroEthylene (“ECTFE”) polymers, and/or PolyVinyliDene Fluoride (“PVDF”, and/or PolyVinyl Chloride (PVC). A plasticizer may be added to the material to produce flexibility to the protective jacket 300.

The protective jacket 300 has a thickness 302 between 0.01 inches to 0.200 inches. For example, in some scenarios, the protective jacket 300 has a thickness of about 0.01 inches to about 0.05 inches, about 0.02 inches to about 0.04 inches, about 0.02 inches, about 0.03 inches, or about 0.04 inches. The present solution is not limited to the particulars of this example.

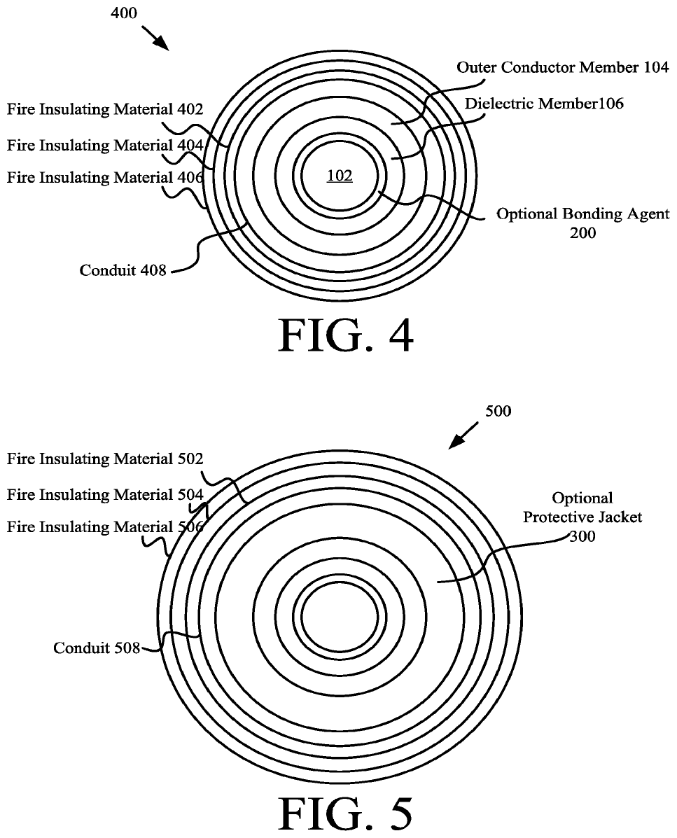

A conduit wrapped in a fire insulating material can be used to transform the coaxial cable 100 into a CI cable. As shown in FIGS. 4-5, the CI cable 400, 500 comprises a conduit 408 encompassed by layers of a fire insulating material 402/404/406, 502/504/506. The coaxial cable 100 (with or without the optional protective jacket 300) is disposed inside the conduit 408, 508. The fire insulating material includes, but is not limited to, a fire barrier packing material PM4 available from 3M of Maplewood, Minn., and/or an Interam™ Endothermic Mat available from 3M of Maplewood, Minn. Notably, FIGS. 4-5 are also not drawn to scale for drawing simplicity and clarity.

Although three layers of the fire insulting material is shown in FIGS. 4-5, the present solution is not limited in this regard. Any number of fire insulating material layers can be employed herein in accordance with a given application. For example, the CI cable has N layers of fire insulating material, where N is an integer between 0 and 100.

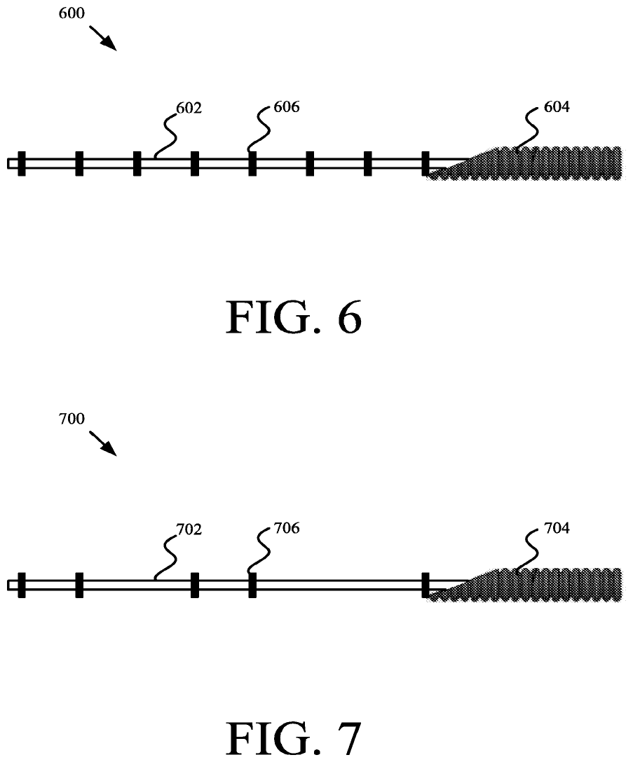

The present solution is not limited to the coaxial cable architecture discussed above in relation to FIGS. 1-5. For example, in other scenarios, the dielectric member comprises a plurality of discs 606, 706 as shown in FIGS. 6-7, rather than a rope. The discs 606, 706 are disposed along the elongate length of the inner conductor member 602, 702. The discs 606, 706 are spaced apart from each other. Adjacent discs can have the same spacing as shown in FIG. 6 or different spacing as shown in FIG. 7. The discs 606, 706 may optionally be coupled, attached or adhered to the inner conductor member 602, 702 via a bonding agent (e.g., an adhesive) or chemical bond (e.g., via an injection molding process). Notably, FIGS. 6-7 are not drawn to scale for drawing simplicity and clarity.

As noted above, conventional coaxial cables fail at about 300° F. This failure is due to the fact that the dielectric member is a layer formed of a polyethelene material that could be solid, foamed, or extruded shape that has a softening point around 300° F. In contrast, the discs 606, 706 provide a dielectric member that does not have a solid layer arrangement but rather a non-solid arrangement formed over the inner conductor member 602, 702. The discs are formed of a silica material (a) with a melting point equal to or greater than 1500° F., (b) that does not experiences a transformation from a flexible material to a rigid material when exposed to temperatures less than 1000° F., and (c) that comprises 60% or more silica. Such a material can include, but is not limited to, a silica rubber. A cable 600, 700 that is operative at temperatures greater than 300° F. is surprising and an unexpected result from use of such a non-solid layer of silica material.

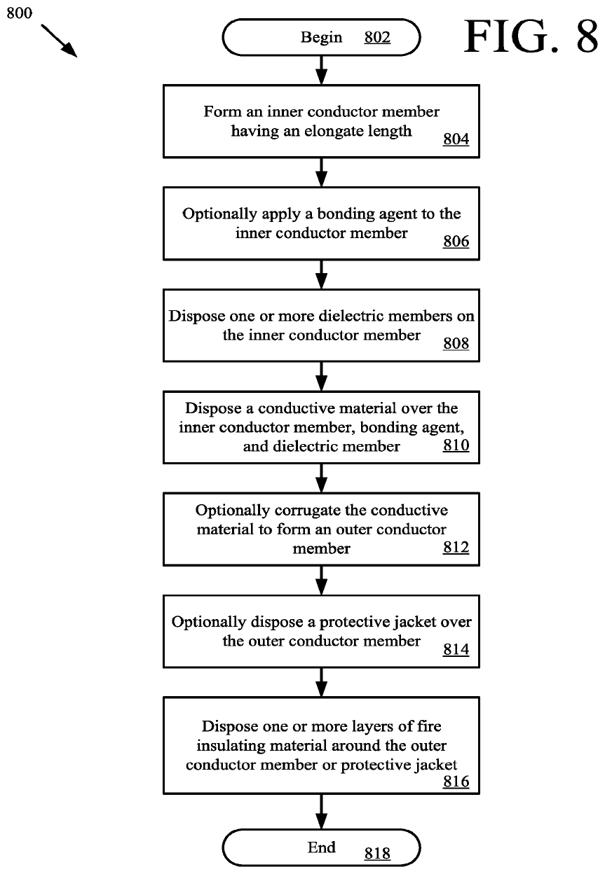

Referring now to FIG. 8, there is provided a flow diagram of an illustrative method 800 for making a CI cable (e.g., CI cable 400 FIG. 4 or 500 of FIG. 5) in accordance with the present solution. Method 800 begins with 802 and continues with 804 where an inner conductor member (e.g., inner conductor member 102 of FIG. 1) is formed. The inner conductor member is flexible and has an elongate length. The inner conductive member is formed of a conductive material (e.g., copper and/or aluminum). The inner conductor member comprises a solid wire, a hollow wire, a stranded wire, a corrugated wire, a plated wire, or a clad wire. Techniques for forming the listed types of wires are well known in the art, and therefore will not be described herein. Any known or to be known technique for forming the listed types of wires can be used herein without limitation.

Next in 806, a bonding agent (e.g., bonding agent 200 of FIG. 2) is optionally applied to the inner conductor member. In some scenarios, an extrusion process is performed to apply the bonding agent to the inner conductor. The extrusion process involves: heating the inner conductor member to an elevated temperature to remove moisture or other contaminants on the surface thereof; and feeding the inner conductor member through an extruder where a pre-coat of an adhesive bonding agent is applied. The present solution is not limited to the particulars of these scenarios.

One or more dielectric members (e.g., dielectric member 106 of FIG. 1, dielectric members 606 of FIG. 6, or dielectric members 706 of FIG. 7) are disposed on the inner conductor member, as shown by 808. The dielectric member(s) can include, but is(are) not limited to, a dielectric rope or dielectric discs. In the rope scenario, the dielectric member is helically wrapped around the inner conductor member. In the disc scenarios, the discs are either (1) slid onto the inner conductor member, (2) injection molded onto the inner conductor member, or (3) extruded directly onto the inner conductor member. Injection molding and extrusion processes are well known in the art, and therefore will not be described herein.

In 810, a conductive material is disposed over the inner conductor member, the bonding agent and/or the dielectric member. This disposition involves drawing the conductive material over the other members, helically winding the conductive material around the other members, longitudinally pulling the conductive material onto the other members, braiding the conductive material onto the other members, extruding the conductive material onto the other members, and/or plating the other members with the conductive material.

In the extrusion scenarios, the result of 808 is fed through an extruder where a pre-coat of an adhesive bonding agent is applied. The pre-coated structure is then fed through the same or another extruder where the conductive material is applied. In some non-extrusion scenarios, a strip of the conductive material is seam welded into a tube. The tube is then drawn over the helically wrapped inner conductor in a continuous process. The present solution is not limited to the particulars of these scenarios.

The conductive material may be optionally annually corrugated in 812. The corrugation process may involve welding a strip into a tube and corrugating the structure. The present solution is not limited to the particulars of this corrugation process.

As a result of the corrugation process, a series of spaced apart crests are formed along an elongate length of the conductive material. The crests are vertically and horizontally aligned with each other so as to have a generally parallel arrangement. Valleys are provided between adjacent crests. As such, the crests are discontinuous along the elongate length of the coaxial cable. Similarly, the valleys are discontinuous along the length of the coaxial cable. In this regard, it should be understood that each crest and valley extends around the circumference of the conductor material only once, until it meets itself, and does not continue in the longitudinal direction.

Upon completing 812, method 800 continues with 814 where a protective jacket (e.g., protective jacket 300 of FIG. 3) is optionally disposed on the structure resulting from 812. Techniques for disposing a protective jacket on a cable structure are well known in the art, and therefore will not be described herein. Any known or to be known technique for disposing a protective jacket on a cable structure can be used herein. In some scenarios, 814 involves performing an extrusion process or a lamination process. A bonding agent may optionally be applied to the cable structure resulting from 812 prior to the application of the protective jacket thereto. Additionally or alternatively, the protective jacket is optionally heated so that it shrinks or a chemical bond is formed between itself and the underlying material.

In next 816, one or more layers of a fire insulating material (e.g., fire insulating material 402, 404, 406 of FIG. 4 or 502, 504, 506 of FIG. 5) is disposed around the cable structure resulting from 810, 812 or 814. 816 can involve wrapping one or more layers of a fire barrier packing tape around the cable structure. Subsequently, 818 is performed where method 800 ends or other processing is performed.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

1. An electrical cable, comprising:
an inner conductor member formed of a conductive material;
a dielectric member disposed as a single non-solid layer on the inner conductor member such that the inner conductor member is only partially covered by the dielectric member, the dielectric member being formed of a flexible silica material (a) with a melting point equal to or greater than 1500° F., (b) that does not experience a transformation from a flexible material to a rigid material when exposed to temperatures less than 1000° F., and (c) that comprises 60% or more silica; and
an outer conductor member that is formed of a conductive material, encompasses the dielectric member and the inner conductor member, and is coaxial with the inner conductor member.

2. The electrical cable according to claim 1, wherein material of the dielectric member has a melting point equal to or greater than 1850° F. or 2200° F.

3. The electrical cable according to claim 1, wherein the flexible silica material does not experiences a transformation from a flexible material to a rigid material when exposed to temperatures less than 1850° F.

4. The electrical cable according to claim 1, wherein the dielectric member comprises a rope.

5. The electrical cable according to claim 4, wherein the rope is helically wrapped around the inner conductor member.

6. The electrical cable according to claim 5, wherein a lay length of the rope is between 1.0 inches and 1.5 inches.

7. The electrical cable according to claim 5, wherein the dielectric member is formed of silica.

8. The electrical cable according to claim 1, wherein the dielectric member comprises a plurality of discs.

9. The electrical cable according to claim 8, wherein the plurality of discs are formed of a silica rubber.

10. The electrical cable according to claim 8, wherein adjacent discs have equal spacing therebetween.

11. The electrical cable according to claim 8, wherein adjacent discs have different spacing therebetween.

12. The electrical cable according to claim 1, wherein the dielectric member is coupled to the inner conductor member.

13. The electrical cable according to claim 1, wherein the outer conductor member is corrugated.

14. The electrical cable according to claim 1, further comprising a protective jacket encasing the outer conductor member.

15. The electrical cable according to claim 1, wherein the electrical cable is transformed into a circuit integrity cable structure using a conduit wrapped in at least one layer of fire insulating material.

16. The electrical cable according to claim 14, wherein the circuit integrity cable structure meets a UL 2196 Compliance Standard.

17. The electrical cable according to claim 1, wherein diameters of the inner conductor member, dielectric member, and outer conductor member are selected to produce an impedance value for the electrical cable of 50 ohms or 75 ohms.

18. A method for making an electrical cable, comprising:
forming an inner conductor member from a conductive material;
disposing a dielectric member as a single non-solid layer on the inner conductor member such that the inner conductor member is only partially covered by the dielectric member, the dielectric member formed of a flexible silica material (a) with a melting point equal to or greater than 1500° F., (b) that does not experience a transformation from a flexible material to a rigid material when exposed to temperatures less than 1000° F., and (c) that comprises 60% or more silica; and
forming an outer conductor member from a conductive material, the outer conductor member encompassing the dielectric member and the inner conductor member, and is coaxial with the inner conductor member.

19. The method according to claim 18, wherein the dielectric member comprises a rope.

20. The method according to claim 18, wherein the dielectric member comprises a plurality of spaced apart discs.
